(19) United States
(12) Patent Application Publication
(10) Pub. No.: US 2025/0298738 A1
(43) Pub. Date: Sep. 25, 2025

(54) PROGRAMMABLE REFRESH CONFIGURATION FOR MEMORY DEVICES

(71) Applicant: Micron Technology, Inc., Boise, ID (US)

(72) Inventors: Martin Brox, München (DE); Thomas Hein, München (DE); Filippo Vitale, Dachau (DE)

(21) Appl. No.: 19/071,585

(22) Filed: Mar. 5, 2025

Related U.S. Application Data
(60) Provisional application No. 63/569,633, filed on Mar. 25, 2024.

(51) Int. Cl. G06F 12/02; G06F 12/14

(52) U.S. Cl. CPC G06F 12/023; G06F 12/1491; G06F 2212/1052

(57) ABSTRACT

Methods, systems, and devices for a programmable refresh configuration for memory devices are described. A memory system may monitor a state of refresh configuration circuitry of the memory system. The refresh configuration circuitry may be one or more fuses, mode registers, or any combination thereof. A first state of the refresh configuration circuitry may indicate that the memory system operates in a first refresh mode associated with a first quantity of refresh operations. A second state of the refresh configuration circuitry may indicate that the memory system operates in a second refresh mode associated with a second quantity of refresh operations. The memory system may receive a refresh command and may execute one or more refresh operations based on the refresh command. A quantity of refresh operations that are executed may be equal to the first quantity or the second quantity based on the state of the refresh configuration circuitry.

### CROSS REFERENCE

The present Application for Patent claims priority to U.S. Patent Application No. 63/569,633 by Brox et al., entitled “PROGRAMMABLE REFRESH CONFIGURATION FOR MEMORY DEVICES,” filed Mar. 25, 2024, which is assigned to the assignee hereof, and which is expressly incorporated by reference in its entirety herein.

### TECHNICAL FIELD

The following relates to one or more systems for memory, including a programmable refresh configuration for memory devices.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports a programmable refresh configuration for memory devices in accordance with examples as disclosed herein.

FIGS. 2A and 2B show example refresh timing diagrams that support a programmable refresh configuration for memory devices in accordance with examples as disclosed herein.

FIG. 3 shows an example of a process flow that supports a programmable refresh configuration for memory devices in accordance with examples as disclosed herein.

FIG. 4 shows a block diagram of a memory system that supports a programmable refresh configuration for memory devices in accordance with examples as disclosed herein.

FIGS. 5 and 6 show flowcharts illustrating a method or methods that support a programmable refresh configuration for memory devices in accordance with examples as disclosed herein.

### DETAILED DESCRIPTION

In some memory systems, one or more memory cells (e.g., a row) may be subject to adverse accessing (e.g., access operations), such as row hammer attacks. A row hammer attack may include repeated access operations to one or more first rows of memory cells (e.g., an aggressor row) within a memory array, which may adversely affect one or more neighboring rows (e.g., victim rows, adjacent rows). For example, repeatedly accessing a row may disturb memory cells of one or more neighboring rows such that data stored by the memory cells may be modified (e.g., compromised, corrupted). Refresh operations may reduce or mitigate (e.g., avoid) such adverse effects. A refresh operation may include refreshing the state (e.g., logic state, electrical state) of the memory cells of one or more of the victim rows (e.g., to restore their correct state). A host device or a memory system controller may issue a refresh command to initiate a refresh operation within a memory device. Some memory devices may be configured to reduce vulnerability of the device to adverse accessing by performing multiple refresh operations to refresh multiple rows of memory cells in response to a single refresh command, which may be referred to as a multi-pump refresh, in some examples. However, some memory devices (e.g., graphics systems, among other types of systems) may be less vulnerable to adverse accessing than other memory devices. For such memory devices, performing multiple refresh operations per refresh command may unnecessarily increase latency and processing.

Techniques described herein provide for configuration of a memory device according to either a single refresh mode or a multi-refresh mode based on one or more characteristics of the device. For example, the memory device may include refresh configuration circuitry that may be set to one or more states, and the memory device may be configured to operate in either a single refresh mode or a multi-refresh mode based on a state of the refresh configuration circuitry. A memory device that operates in the single refresh mode may perform a single refresh to refresh a single row of memory cells in response to a single refresh command. The memory device may not perform other refresh operations until the memory devices receives additional refresh commands. A memory device that operates in the multi-refresh mode may perform multiple (e.g., two or more) refreshes to refresh multiple rows of memory cells in response to a single refresh command. A quantity of refreshes that are performed for each command may be a parameter or characteristic of the device. The refresh configuration circuitry may be or include a fuse, a mode register, or some other type of circuitry. In some examples, the state of the refresh configuration circuitry may be set at different stages, such as during manufacture of the device (e.g., a fuse may be blown), and the memory device may operate in a refresh mode corresponding to the state for a lifetime of the memory device. For example, a test flow may determine whether a memory die is to be used in a row-hammer-vulnerable environment or a non-row-hammer-vulnerable environment, and may determine whether to blow the one or more fuses accordingly. Additionally, or alternatively, the state of the refresh configuration circuitry may be dynamically changed from one state to one or more others (e.g., by resetting a value of a mode register) throughout the lifetime of the memory device.

In addition to applicability in memory systems as described herein, techniques for a programmable refresh configuration for memory devices may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by permitting some memory systems, such as graphics systems, automotive graphics systems, or other types of systems that are less vulnerable to row hammer attacks, to operate in a single refresh mode, which may decrease processing or latency times, improve response times, or otherwise improve user experience, among other benefits.

Features of the disclosure are illustrated and described in the context of systems and architectures. Features of the disclosure are further illustrated and described in the context of refresh timing diagrams, a process flow, and flowcharts.

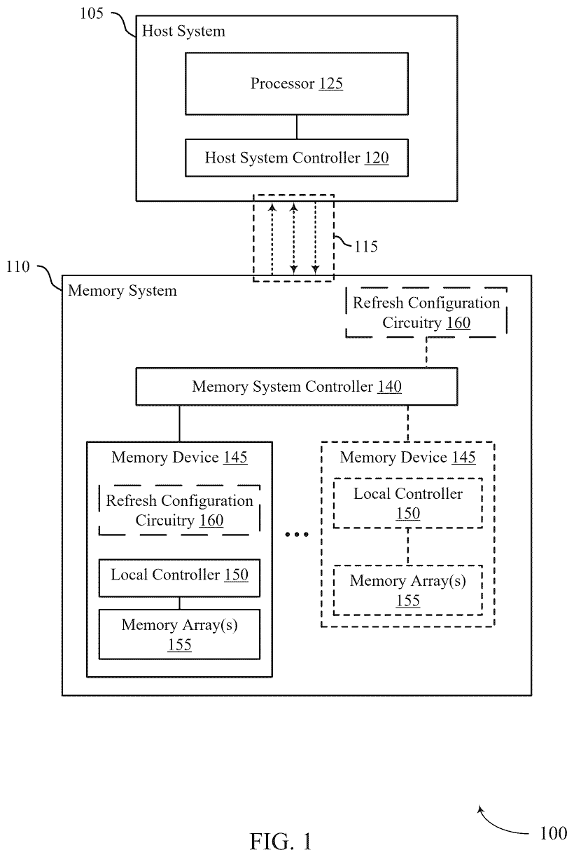

FIG. 1 illustrates an example of a system 100 that supports a programmable refresh configuration for memory devices in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples of the system 100, the memory system 110 may implement multi-pump refresh operations to address row hammer attacks. That is, a memory device 145 may perform multiple refreshes (e.g., two or more) in each external refresh cycle. An external refresh cycle may be associated with a refresh command from the host system 105, the memory system controller 140, or both. The two refreshes may include a refresh of a first word line and a refresh of a second word line and may be performed as a sequence of refresh operations, which may extend a duration per refresh cycle as compared with a single refresh operation. For example, a double-pump refresh may consume (e.g., occupy, take) twice the amount of time as a single-pump refresh, and an N-pump refresh may consume N times the amount of time. The memory system controller 140 may not access the bank that is being refreshed during the one or more refresh operations. According, the extended duration due to multi-pump refresh may increase latency and processing relative to single-pump refresh.

Some memory systems 110 or memory devices 145, or both, may be less vulnerable to or may not be affected by access attacks, such as row hammer. For example, a graphics system may not be impacted by access attacks very frequently, if at all, due to a configuration of the graphics system, which may include a GPU system that may operate behind a CPU system. The GPU system may not be easily programmed in an arbitrary manner (e.g., to get a virus running on the GPU to hammer word line is difficult and unlikely). If such low-risk systems are configured to perform multi-pump refresh, there may be a performance reduction related to the system stalling and refraining from accessing the refreshed bank for a length of the refresh in case data from the refreshed bank is needed for other operations.

Techniques described herein provide for a memory device 145 to operate in either a single refresh mode or a multi-refresh mode depending on a vulnerability or likelihood that the memory device 145 is subject to an access attack. If the likelihood of the memory device 145 experiencing an access attack is below a threshold, the memory device 145 may be configured to operate in the single refresh mode, in which the memory device 145 may perform a single-pump refresh. If the likelihood of the memory device 145 experiencing an access attack exceeds the threshold, the memory device 145 may be configured to operate in the multi-refresh mode, in which the memory device may perform multi-pump refresh. A memory system 110 may thereby be distinguished as a vulnerable system (e.g., vulnerable to row hammer) or a non-vulnerable system, and multi-pump refresh may be enabled for the vulnerable systems while single-pump refresh may be enabled for the non-vulnerable systems.

The memory system 110 may include refresh configuration circuitry 160 that is operable to indicate the refresh mode for one or more memory devices 145. The refresh configuration circuitry 160 may be positioned on one or more memory devices 145 or may be positioned elsewhere within the memory system 110. If the refresh configuration circuitry 160 is local to the memory device 145, the refresh configuration circuitry 160 may indicate a refresh mode for each memory device 145 independently. If the refresh configuration circuitry 160 is external to the memory devices 145, the refresh configuration circuitry 160 may be coupled with the memory system controller 140 and may be able to indicate a refresh mode for multiple memory devices 145 in the memory system 110. The refresh configuration circuitry may include one or more fuses, one or more mode registers (e.g., one or more register bits), some other circuitry, or any combination thereof that is configured to be set to two or more different states that indicate two or more different refresh modes.

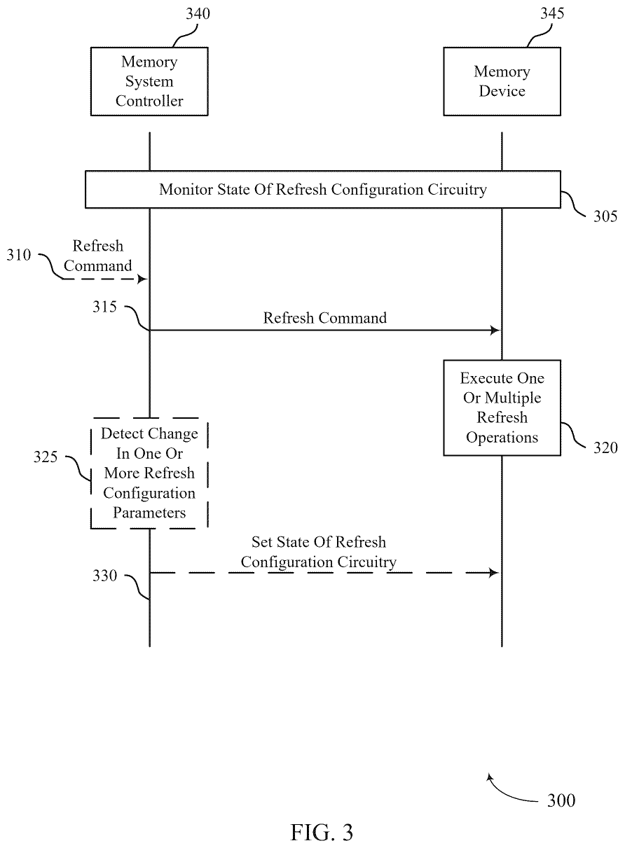

If the refresh configuration circuitry 160 includes one or more fuses, the fuses may be blown or may not be blown during manufacture of the memory system 110. If the fuses are blown, the refresh configuration circuitry 160 may be set to a first state that indicates the one or more memory devices 145 are to operate in a given refresh mode, such as the single refresh mode. If the fuses are not blown, the refresh configuration circuitry 160 may be set to a second state that indicates the one or more memory devices 145 are to operate in a second given refresh mode, such as a multi-refresh mode. If the refresh configuration circuitry 160 includes one or more mode registers, a value of the one or more mode registers may indicate which state and corresponding refresh mode the memory devices 145 are to operate in. The value of the mode register(s) may be set by the memory system controller 140, the host system 105, or both (e.g., a controller-accessible mode register), among other examples. The mode register(s) may be updated once per lifetime of the memory system 110 or dynamically one or more times throughout the lifetime of the memory system 110 (e.g., the memory system controller 140 may flexibly decide whether to enable row hammer protection or not), as described in further detail with reference to FIG. 3. The memory system 110 may thereby operate in either a single refresh mode or a multi-refresh mode based on a state of the refresh configuration circuitry 160, which may provide for improved security and reliability of stored data while reducing or otherwise optimizing latency and processing, among other benefits.

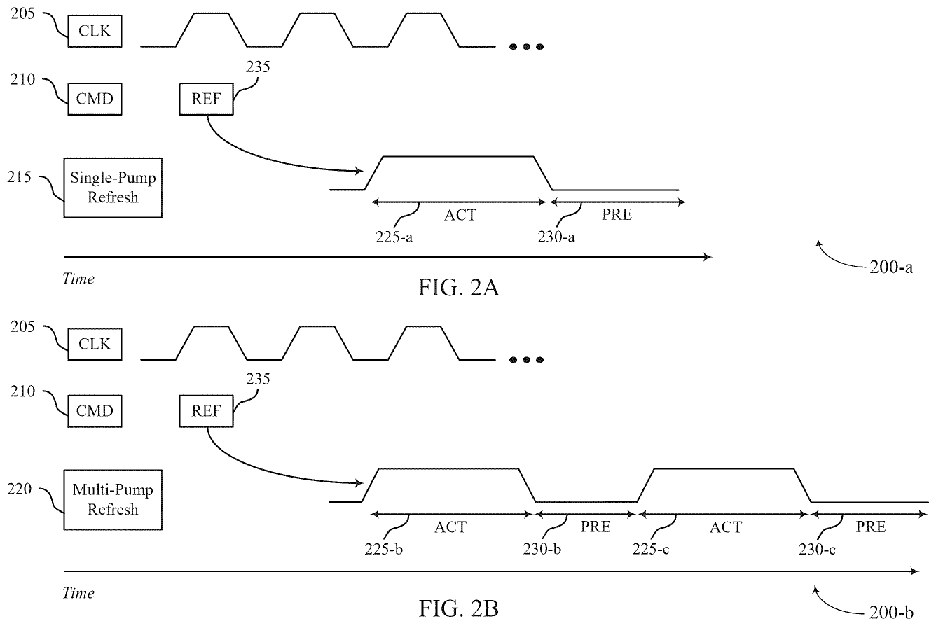

FIGS. 2A and 2B illustrate example refresh timing diagrams 200 that support a programmable refresh configuration for memory devices in accordance with examples as disclosed herein. The refresh timing diagrams 200 may implement or may be implemented by aspects of the system 100 or one or more components thereof (e.g., the host system 105, the memory system 110, the memory system controller 140, a memory device 145). The refresh timing diagrams 200 illustrate example refresh operations performed in different types of refresh modes supported by a memory device.

The refresh timing diagrams 200-a and 200-b illustrate example refresh operations performed over time relative to a clock cycle 205 and a sequence of one or more commands 210. Aspects of the refresh timing diagrams 200-a and 200-b may be implemented by a memory system controller 140, a host system 105, a memory device 145, a local controller 150, or any combination thereof, among other components. Alternative examples of the refresh timing diagrams 200-a and 200-b may be implemented in which some operations are performed in a different order than described, are performed at different relative times than described, or are not performed at all. In some cases, operations may include features not mentioned below, or additional operations may be added.

FIG. 2A illustrates a first example refresh timing diagram 200-a. In this example, the refresh configuration circuitry at the memory device may be set to a first state associated with (e.g., indicative of) a first refresh mode, which may be a single refresh mode. The single refresh mode may be associated with execution, by the memory device, of a single-pump refresh operation 215 in response to a refresh command 235.

As described herein, the memory device may receive (e.g., at a memory system controller or a local controller) the refresh command 235. The refresh command 235 may be transmitted by a host system, a memory system controller, or some other component. The refresh command 235 may trigger a refresh operation by the memory device. In some examples, the refresh command 235 may indicate a memory address or a certain row to be refreshed. The refresh command 235 may be transmitted in a first cycle of the clock cycle 205.

In this example, the memory device may perform a single-pump refresh operation 215 in response to the single refresh command 235 based on the memory device operating in the single refresh mode. To perform the single-pump refresh operation 215, the memory device may refresh a single row of memory cells. The refresh may start one or more clock cycles after the refresh command 235 is received. To initiate the refresh, the memory device may activate, during an activate duration 225-a, a word line associated with the target row of memory cells. The activation may access the row of memory cells such that the charge stored on the memory cells is read out and sensed. By activating the word line, the memory device may restore an electrical charge on the memory cells in the row. For example, the electrical charge stored on the memory cells may be written back to the cells as part of the refresh duration. After the activate duration 225-a, the memory device may precharge the word line during a precharge duration 230-a. A single refresh operation to refresh a single word line may include the activate duration 225-a and the precharge duration 230-a.

The memory device may thereby refresh a single row of memory cells in response to the single refresh command 235 when the memory device operates in the single refresh mode.

FIG. 2B illustrates a second example refresh timing diagram 200-b. In this example, the refresh configuration circuitry at the memory device may be set to a second state associated with (e.g., indicative of) a second refresh mode, which may be a multi-refresh mode. The multi-refresh mode may be associated with execution, by the memory device, of a multi-pump refresh operation 220 in response to a refresh command 235.

As described herein, the memory device may receive (e.g., at a memory system controller or a local controller) the refresh command 235. The refresh command 235 may be transmitted by a host system, a memory system controller, or some other component. The refresh command 235 may trigger a refresh operation by the memory device. In some examples, the refresh command 235 may indicate a memory address or a certain row to be refreshed. The refresh command 235 may be transmitted in a first cycle of the clock cycle 205.

In this example, the memory device may perform the multi-pump refresh operation 220 in response to the single refresh command 235 based on the memory device operating in the multi-refresh mode. To perform the multi-pump refresh operation 220, the memory device may refresh two or more rows of memory cells in response to the single refresh command 235. The memory device may refresh the two or more rows of memory cells consecutively or within a threshold duration after the refresh command 235 is received. In some examples, the refresh command 235 may indicate a memory address associated with a victim word line that is subject to or vulnerable to a potential row hammer attack (e.g., a row address RA). The row hammer attack to the victim word line may leave neighboring word lines vulnerable. Accordingly, the multi-pump refresh operation 220 may refresh the neighboring (e.g., adjacent) word lines to the victim word line (e.g., word lines RA−1 and RA+1 may be refreshed) in a single external row hammer mitigation refresh cycle.

In the example illustrated in FIG. 2B, the memory device may refresh a first row of memory cells during the activate duration 225-b and the precharge duration 230-b, and the memory device may consecutively refresh a second row of memory cells during the activate duration 225-c and the precharge duration 230-c. That is, the memory device may perform a sequence of refreshes, without performing other operations between the refreshes (e.g., back-to-back refreshes). In some examples, the memory device may refresh three rows of memory cells, or some other quantity of rows.

The refreshes may be performed consecutively or within a threshold duration. For example, the memory device may support a certain duration for refresh, and the memory device may perform as many refreshes as possible within the duration. Additionally, or alternatively, the memory device may perform the refresh operations consecutively, such that there is no time gap between each consecutive refresh.

The memory device may thereby refresh multiple rows of memory cells in response to the single refresh command 235 when the memory device operates in the multi-refresh mode. A total duration of the multi-pump refresh operation 220 may be greater than a total duration of the single-pump refresh operation 215 (e.g., two times as long). The one or more rows being refreshed may not be accessed during the refresh operations, which may stall operation of the memory system. Accordingly, the multi-pump refresh operation 220 may increase latency and processing relative to the single-pump refresh operation 215. However, the multi-pump refresh operation 220 may reduce vulnerability to row hammer attacks by a greater amount than the single-pump refresh operation 215.

The described techniques may thereby provide for selection of either a first refresh mode in which the memory system performs the single-pump refresh operation 215 for each refresh command 235 or a second refresh mode in which a memory system performs the multi-pump refresh operation 220 for each refresh command 235 based on one or more parameters or conditions associated with the memory system. The one or more parameters or conditions may indicate whether the memory system operates in an environment (e.g., executes applications) that is vulnerable to access attacks or not. The mode in which the memory system operates may be indicated via refresh configuration circuitry, as described in further detail elsewhere herein, including with reference to FIGS. 1 and 3.

FIG. 3 shows an example of a process flow 300 that supports a programmable refresh configuration for memory devices in accordance with examples as disclosed herein. The process flow may illustrate a process that may be implemented by a system 100 (or one or more components thereof), as described with reference to FIGS. 1 and 2. The process flow 300 may illustrate a process for dynamically setting a refresh mode of a memory device 345 and performing a single refresh operation or multiple refresh operations per refresh command, accordingly, as described with reference to FIGS. 1 and 2. The memory device 345 may represent an example of a memory device 145, as described with reference to FIG. 1. The memory device 345 may be coupled with a memory system controller 340, which may control operations by the memory device 345 and one or more other memory devices 345 in a memory system. The memory system controller 340 may represent an example of the memory system controller 140 described with reference to FIG. 1.

Aspects of the process flow may be implemented by a controller (e.g., a memory system controller 340, a local controller 150), among other components. Additionally, or alternatively, aspects of the process flow 300 may be implemented as instructions stored in memory (e.g., firmware stored in a memory coupled with a memory device, the memory system controller, or both). For example, the instructions, if executed by a controller (e.g., the memory system controller 340 or a storage controller), may cause the controller to perform the operations of the process flow 300. Alternative examples of the process flow 300 may be implemented in which some operations are performed in a different order than described or are not performed at all. In some cases, operations may include features not mentioned below, or additional operations may be added.

At 305, the memory device 345, the memory system controller 340, or both may monitor a state of refresh configuration circuitry of the memory system. The refresh configuration circuitry may be or include one or more fuses, a mode register, or some other component that is configured to indicate a refresh mode for the memory device 345, as described with reference to FIG. 1. The state of the refresh configuration circuitry may be the one or more fuses being blown or not blown, one or more values stored in the mode register, other options for storing one or more states, or any combination thereof. In some examples, the refresh configuration circuitry may be positioned on or otherwise coupled with the memory device 345. The memory device 345 may monitor the state of the refresh configuration circuitry to determine whether to operate in a single refresh mode or a multi-refresh mode. Additionally, or alternatively, the refresh configuration circuitry may be positioned elsewhere in the memory system, and may be coupled with the memory device 345 and the memory system controller 340. In such cases, the state of the refresh configuration circuitry may indicate a refresh mode for the memory device 345 and one or more other memory devices in the memory system.

In some examples, the memory device 345 may receive signaling or a command from the memory system controller 340 that indicates to set the refresh configuration circuitry (e.g., a mode register) to a first value or a second value. In such cases, monitoring the refresh configuration circuitry may be based on the signaling.

At 310, a refresh command may be received. In some examples, the refresh command may be received at the memory system controller 340 from a host system. At 315, the refresh command may be sent from the memory system controller 340 to the memory device 345. In some examples, the memory system controller 340 may forward the refresh command from the host system to the memory device 345. Additionally, or alternatively, the memory system controller 340 may generate and initiate the refresh command. The refresh command may be transmitted periodically or in response to one or more refresh conditions. For example, if the host system or the memory system controller 340 detect a row hammer attack or other vulnerability, the host system or the memory system controller 340 may issue the refresh command to a certain set of one or more word lines in the memory device 345 to refresh memory cells and reduce vulnerability to attacks. In some examples, the refresh command may indicate a row address associated with a refresh operation. The refresh command may initiate an external row hammer mitigation cycle, in some examples.

At 320, the memory device 345 may execute one or more refresh operations based on (e.g., in response to, after) the refresh command (e.g., during the external row hammer mitigation cycle). A quantity of operations that are executed based on the refresh command may be equal to a first quantity associated with a first refresh mode supported by the memory device 345 or a second quantity associated with a second refresh mode supported by the memory device 345. The memory device 345 may operate in either the first refresh mode or the second refresh mode based on the state of the refresh configuration circuitry, as determined at 305.

If the state of the refresh configuration circuitry is a first state (e.g., a first mode register value or one or more fuses that are not blown), the memory device 345 may operate in a first refresh mode associated with a single refresh operation. In such cases, at 320, the memory device 345 may execute a single refresh operation based on the refresh command. The single refresh operation may refresh a single row of memory cells, and may represent an example of the single-pump refresh operation 215 described with reference to FIG. 2A. In some examples, the memory device 345 may subsequently receive one or more second refresh commands, and the memory device 345 may execute a single refresh operation based on each refresh command and based on the memory device 345 operating in the first refresh mode (e.g., a single refresh mode).

If the state of the refresh configuration circuitry is a second state (e.g., a second value or one or more blown fuses), the memory device 345 may operate in a second refresh mode associated with at least two refresh operations. In such cases, at 320, the memory device 345 may execute multiple refresh operations based on the refresh command. That is, in response to receipt of the refresh command, the memory device 345 may execute a sequence of refresh operations to refresh multiple rows of memory cells. The multiple refresh operations may represent an example of the multi-pump refresh operation 220 described with reference to FIG. 2B. In some examples, the memory device 345 may subsequently receive one or more second refresh commands, and the memory device 345 may execute multiple refresh operations based on each refresh command and based on the memory device 345 operating in the second refresh mode (e.g., a multi-refresh mode). A quantity of refresh operations that are performed in response to each refresh command in the second refresh mode may be based on the state of the refresh configuration circuitry (e.g., a value of the mode register), based on one or more settings or instructions at the memory device 345, based on one or more instructions received from an external device (e.g., the host system, the memory system controller 340), or any combination thereof.

In some examples, at 325, the memory system controller 340 may detect a change in one or more parameters associated with a refresh configuration for the memory device 345. For example, the memory system controller 340 or some other device (e.g., the host system) may detect that at least a threshold quantity of access operations are executed in one or more memory locations within a threshold duration. That is, the memory system controller 340 may detect an access attack to one or more memory locations within the memory device 345, and the change in the one or more parameters may be based on the detected access attack.

In some other examples, the memory system controller 340 may receive a request to change a refresh mode of the memory device 345. The request may be received from the memory device 345, another memory device in the memory system, a host system, a user, or any combination thereof. The change in the one or more parameters may be based on the request. In some examples, if the memory device 345 detects a row hammer attack or a quantity of repeated accesses within a threshold duration, the memory device 345 may set a flag (e.g., a pin or some other indication) to indicate, to the memory system controller 340, that the memory device 345 may benefit from more time for additional refresh operations, and the memory system controller 340 may determine to switch to the second refresh mode accordingly. Additionally, or alternatively, the memory system controller 340 may detect one or more other parameters that are indicative of a vulnerability of the memory device 345 to a threshold quantity of access operations executed in the one or more memory locations within a threshold duration, or some other vulnerability at the memory device 345. In some examples, the change in the one or more parameters may indicate a change in a type of application supported by the memory device 345 or an operating environment of the memory device 345.

At 330, in some examples, the memory system controller 340 may set a state of the refresh configuration circuitry at the memory device 345 based on (e.g., in response to) the detected change in the one or more parameters associated with the refresh configuration circuitry. For example, if the change in the one or more parameters indicates that the memory device 345 is less vulnerable to an access attack (e.g., a quantity of access operations is less than a threshold quantity within a threshold duration, an application supported by the memory device 345 changes to an application less susceptible to row hammer, or the like), the memory system controller 340 may set the state of the refresh configuration circuitry to a first state associated with the first refresh mode. As such, the memory device 345 may perform a single refresh operation per external refresh command, which may reduce latency and processing in a relatively low-risk scenario. If the change in the one or more parameters indicates that the memory device 345 is more vulnerable to an access attack (e.g., at least a threshold quantity of access operations within a threshold duration, a change in applications supported by the memory device 345 to an application that is more susceptible to row hammer, or the like), the memory system controller 340 may set the state of the refresh configuration circuitry to a second state associated with the second refresh mode. As such, the memory device 345 may perform multiple refresh operations per external refresh command, which may improve security and may reduce vulnerability to attacks.

In some examples, the refresh configuration circuitry may be one or more mode registers that support dynamic adjustment (e.g., one or more adjustments) throughout a lifetime of the memory device 345. The memory system controller 340 may set a value of the mode register associated with the memory device 345 to a first value associated with the first refresh mode or a second value associated with the second refresh mode. The refresh configuration circuitry may be located at the memory device 345 or in some other location within or otherwise coupled with the memory system and the memory system controller 340. In some examples, setting the state of the refresh configuration circuitry may include changing the state from a first state to a second state. Additionally, or alternatively, setting the state may include maintaining the state of the refresh configuration circuitry.

The mode register may be programmable by a customer, in some examples. For example, an administrator or other user that operates a memory system may determine whether to set the memory system in the first refresh mode associated with a single refresh operation or the second refresh mode associated with multiple refresh operations based on an environment for the memory system. The customer request may be input via a user interface, in some examples. In some examples, the mode register functionality may be disclosed in a data sheet for the memory system and may indicate one or more supported values of the mode register and the corresponding refresh modes. Each refresh mode may be associated with a respective refresh duration, in some examples. For example, the single refresh mode may be associated with a first duration (e.g., 100 nanoseconds) and the multi-refresh mode may be associated with a second duration (e.g., 200 nanoseconds) that is greater than the first duration, thereby providing for more refresh operations to be performed.

The memory device 345 may thereby determine whether to execute a single refresh operation or multiple refresh operations per refresh cycle (e.g., per refresh command) based on a refresh mode of the memory device 345. By including refresh configuration circuitry associated with the memory device 345, the memory system may support indication of the refresh mode dynamically or statically (e.g., at manufacture or once per lifetime of the memory device 345), such that the memory system may reduce refresh operation executions if the memory device 345 is less susceptible to attacks and the memory system may increase refresh operation executions if the memory device 345 is more susceptible to attacks. The described techniques my provide for improved security and reliability of data storage within the memory system while reducing unnecessary latency, processing, and power consumption, among other examples.

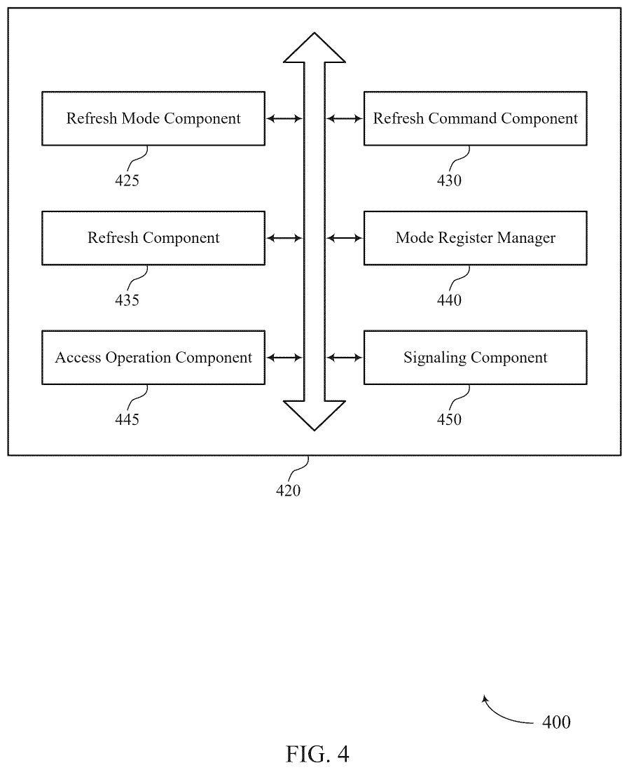

FIG. 4 shows a block diagram 400 of a memory system 420 that supports a programmable refresh configuration for memory devices in accordance with examples as disclosed herein. The memory system 420 may be an example of aspects of a memory system as described with reference to FIGS. 1 through 3. The memory system 420, or various components thereof, may be an example of means for performing various aspects of a programmable refresh configuration for memory devices as described herein. For example, the memory system 420 may include a refresh mode component 425, a refresh command component 430, a refresh component 435, a mode register manager 440, an access operation component 445, a signaling component 450, or any combination thereof. Each of these components, or components of subcomponents thereof (e.g., one or more processors, one or more memories), may communicate, directly or indirectly, with one another (e.g., via one or more buses).

The refresh mode component 425 may be configured as or otherwise support a means for monitoring a state of refresh configuration circuitry of a memory system, where a first state of the refresh configuration circuitry indicates that the memory system operates in a first refresh mode associated with a first quantity of refresh operations and a second state of the refresh configuration circuitry indicates that the memory system operates in a second refresh mode associated with a second quantity of refresh operations. The refresh command component 430 may be configured as or otherwise support a means for receiving a refresh command for a memory array at the memory system. The refresh component 435 may be configured as or otherwise support a means for executing one or more refresh operations based at least in part on the refresh command, where a quantity of refresh operations included in the one or more refresh operations executed based at least in part on the refresh command is equal to the first quantity or the second quantity based at least in part on the state of the refresh configuration circuitry.

In some examples, to support executing the one or more refresh operations, the refresh component 435 may be configured as or otherwise support a means for executing a single refresh operation based at least in part on the refresh command, the single refresh operation based at least in part on the state of the refresh configuration circuitry being the first state associated with the first refresh mode, where the first refresh mode includes a single refresh mode.

In some examples, the refresh command component 430 may be configured as or otherwise support a means for receiving a second refresh command for the memory array at the memory system. In some examples, the refresh component 435 may be configured as or otherwise support a means for executing a second single refresh operation based at least in part on the second refresh command, the second single refresh operation based at least in part on the state of the refresh configuration circuitry being the first state associated with the first refresh mode, where the single refresh operation refreshes memory cells in a first word line of the memory array at the memory system and the second single refresh operation refreshes memory cells in a second word line of the memory array at the memory system.

In some examples, to support executing the one or more refresh operations, the refresh component 435 may be configured as or otherwise support a means for executing at least two refresh operations based at least in part on the refresh command, the at least two refresh operations based at least in part on the state of the refresh configuration circuitry being the second state associated with the second refresh mode, where the second refresh mode includes a multi-refresh mode.

In some examples, to support executing the at least two refresh operations, the refresh component 435 may be configured as or otherwise support a means for executing, based at least in part on the refresh command, a first refresh operation to refresh first memory cells in a first word line of the memory array at the memory system. In some examples, to support executing the at least two refresh operations, the refresh component 435 may be configured as or otherwise support a means for executing, based at least in part on the refresh command, after executing the first refresh operation, and before executing other refresh operations for the memory array, a second refresh operation to refresh second memory cells in a second word line of the memory array at the memory system.

In some examples, the refresh configuration circuitry includes a mode register. In some examples, the first state corresponds to a first value of the mode register. In some examples, the second state corresponds to a second value of the mode register.

In some examples, the signaling component 450 may be configured as or otherwise support a means for receiving signaling that indicates to set the mode register to the first value or the second value, where monitoring the state of the refresh configuration circuitry is based at least in part on the signaling.

In some examples, the refresh configuration circuitry includes one or more fuses on a memory die within the memory system. In some examples, the first state corresponds to the one or more fuses being blown. In some examples, the second state corresponds to the one or more fuses not being blown.

In some examples, the refresh mode component 425 may be configured as or otherwise support a means for detecting a change in one or more parameters associated with a refresh configuration for a memory device. The mode register manager 440 may be configured as or otherwise support a means for setting, based at least in part on the change in the one or more parameters, a value of a mode register associated with the memory device to a first value associated with a first refresh mode of the memory device or to a second value associated with a second refresh mode of the memory device where the first refresh mode is associated with a first quantity of refresh operations and the second refresh mode is associated with a second quantity of refresh operations. In some examples, the refresh command component 430 may be configured as or otherwise support a means for transmitting, to the memory device, a refresh command, where a quantity of refresh operations that is triggered based at least in part on the refresh command is equal to the first quantity or the second quantity based at least in part on the value of the mode register.

In some examples, the access operation component 445 may be configured as or otherwise support a means for detecting at least a threshold quantity of access operations executed in one or more memory locations during a threshold duration, where the change in the one or more parameters is based at least in part on detecting at least the threshold quantity of access operations executed.

In some examples, to support setting the value of the mode register, the mode register manager 440 may be configured as or otherwise support a means for setting the value of the mode register to the first value associated with the first refresh mode of the memory device based at least in part on detecting at least the threshold quantity of access operations executed, where the quantity of refresh operations that is triggered based at least in part on the refresh command is at least two based at least in part on the first value of the mode register.

In some examples, the refresh mode component 425 may be configured as or otherwise support a means for receiving a request to change a refresh mode of the memory device, where the change in the one or more parameters is based at least in part on the request.

In some examples, to support setting the value of the mode register, the mode register manager 440 may be configured as or otherwise support a means for setting the value of the mode register to the first value associated with the first refresh mode, where the first refresh mode includes a single refresh mode, and where the quantity of refresh operations that is triggered based at least in part on the refresh command is one based at least in part on the single refresh mode.

In some examples, to support setting the value of the mode register, the mode register manager 440 may be configured as or otherwise support a means for setting the value of the mode register to the second value associated with the second refresh mode, where the second refresh mode includes a multi-refresh mode, and where the quantity of refresh operations that is triggered based at least in part on the refresh command is at least two based at least in part on the multi-refresh mode.

In some examples, to support setting the value of the mode register, the mode register manager 440 may be configured as or otherwise support a means for transmitting, to the memory device, signaling that indicates to set the value of the mode register to the first value or the second value.

In some examples, the one or more parameters indicate a vulnerability of the memory device to a threshold quantity of access operations executed in one or more memory locations during a threshold duration.

In some examples, the one or more parameters indicate a type of application supported by the memory device.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

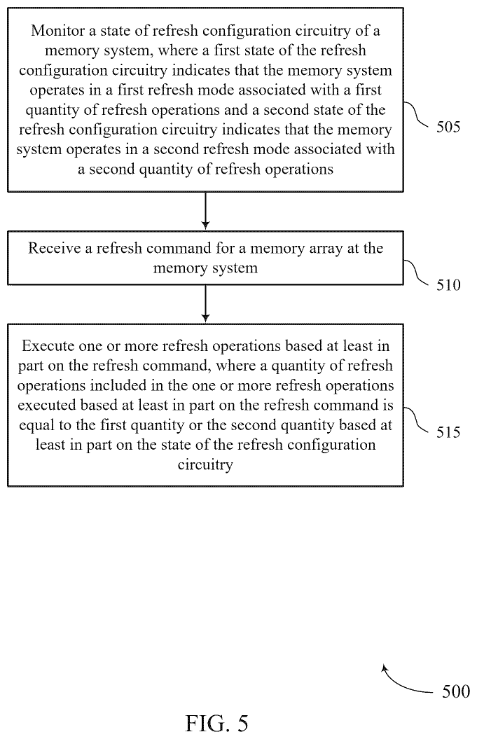

FIG. 5 shows a flowchart illustrating a method 500 that supports a programmable refresh configuration for memory devices in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include monitoring a state of refresh configuration circuitry of a memory system, where a first state of the refresh configuration circuitry indicates that the memory system operates in a first refresh mode associated with a first quantity of refresh operations and a second state of the refresh configuration circuitry indicates that the memory system operates in a second refresh mode associated with a second quantity of refresh operations. In some examples, aspects of the operations of 505 may be performed by a refresh mode component 425 as described with reference to FIG. 4.

At 510, the method may include receiving a refresh command for a memory array at the memory system. In some examples, aspects of the operations of 510 may be performed by a refresh command component 430 as described with reference to FIG. 4.

At 515, the method may include executing one or more refresh operations based at least in part on the refresh command, where a quantity of refresh operations included in the one or more refresh operations executed based at least in part on the refresh command is equal to the first quantity or the second quantity based at least in part on the state of the refresh configuration circuitry. In some examples, aspects of the operations of 515 may be performed by a refresh component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for monitoring a state of refresh configuration circuitry of a memory system, where a first state of the refresh configuration circuitry indicates that the memory system operates in a first refresh mode associated with a first quantity of refresh operations and a second state of the refresh configuration circuitry indicates that the memory system operates in a second refresh mode associated with a second quantity of refresh operations; receiving a refresh command for a memory array at the memory system; and executing one or more refresh operations based at least in part on the refresh command, where a quantity of refresh operations included in the one or more refresh operations executed based at least in part on the refresh command is equal to the first quantity or the second quantity based at least in part on the state of the refresh configuration circuitry.

Aspect 2: The method, apparatus, or non-transitory computer-readable medium of aspect 1, where executing the one or more refresh operations includes operations, features, circuitry, logic, means, or instructions, or any combination thereof for executing a single refresh operation based at least in part on the refresh command, the single refresh operation based at least in part on the state of the refresh configuration circuitry being the first state associated with the first refresh mode, where the first refresh mode includes a single refresh mode.

Aspect 3: The method, apparatus, or non-transitory computer-readable medium of aspect 2, further including operations, features, circuitry, logic, means, or instructions, or any combination thereof for receiving a second refresh command for the memory array at the memory system and executing a second single refresh operation based at least in part on the second refresh command, the second single refresh operation based at least in part on the state of the refresh configuration circuitry being the first state associated with the first refresh mode, where the single refresh operation refreshes memory cells in a first word line of the memory array at the memory system and the second single refresh operation refreshes memory cells in a second word line of the memory array at the memory system.

Aspect 4: The method, apparatus, or non-transitory computer-readable medium of any of aspects 1 through 3, where executing the one or more refresh operations includes operations, features, circuitry, logic, means, or instructions, or any combination thereof for executing at least two refresh operations based at least in part on the refresh command, the at least two refresh operations based at least in part on the state of the refresh configuration circuitry being the second state associated with the second refresh mode, where the second refresh mode includes a multi-refresh mode.

Aspect 5: The method, apparatus, or non-transitory computer-readable medium of aspect 4, where executing the at least two refresh operations includes operations, features, circuitry, logic, means, or instructions, or any combination thereof for executing, based at least in part on the refresh command, a first refresh operation to refresh first memory cells in a first word line of the memory array at the memory system and executing, based at least in part on the refresh command, after executing the first refresh operation, and before executing other refresh operations for the memory array, a second refresh operation to refresh second memory cells in a second word line of the memory array at the memory system.

Aspect 6: The method, apparatus, or non-transitory computer-readable medium of any of aspects 1 through 5, where the refresh configuration circuitry includes a mode register; the first state corresponds to a first value of the mode register; and the second state corresponds to a second value of the mode register.

Aspect 7: The method, apparatus, or non-transitory computer-readable medium of aspect 6, further including operations, features, circuitry, logic, means, or instructions, or any combination thereof for receiving signaling that indicates to set the mode register to the first value or the second value, where monitoring the state of the refresh configuration circuitry is based at least in part on the signaling.

Aspect 8: The method, apparatus, or non-transitory computer-readable medium of any of aspects 1 through 7, where the refresh configuration circuitry includes one or more fuses on a memory die within the memory system; the first state corresponds to the one or more fuses being blown; and the second state corresponds to the one or more fuses not being blown.

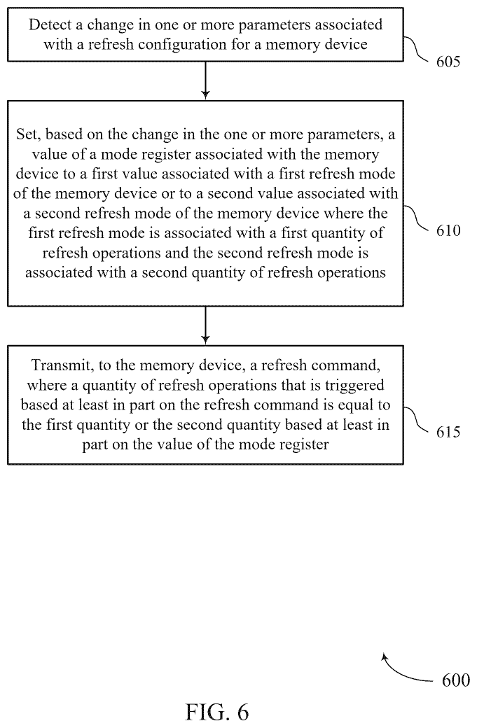

FIG. 6 shows a flowchart illustrating a method 600 that supports a programmable refresh configuration for memory devices in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include detecting a change in one or more parameters associated with a refresh configuration for a memory device. In some examples, aspects of the operations of 605 may be performed by a refresh mode component 425 as described with reference to FIG. 4.

At 610, the method may include setting, based at least in part on the change in the one or more parameters, a value of a mode register associated with the memory device to a first value associated with a first refresh mode of the memory device or to a second value associated with a second refresh mode of the memory device where the first refresh mode is associated with a first quantity of refresh operations and the second refresh mode is associated with a second quantity of refresh operations. In some examples, aspects of the operations of 610 may be performed by a mode register manager 440 as described with reference to FIG. 4.

At 615, the method may include transmitting, to the memory device, a refresh command, where a quantity of refresh operations that is triggered based at least in part on the refresh command is equal to the first quantity or the second quantity based at least in part on the value of the mode register. In some examples, aspects of the operations of 615 may be performed by a refresh command component 430 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for detecting a change in one or more parameters associated with a refresh configuration for a memory device; setting, based at least in part on the change in the one or more parameters, a value of a mode register associated with the memory device to a first value associated with a first refresh mode of the memory device or to a second value associated with a second refresh mode of the memory device where the first refresh mode is associated with a first quantity of refresh operations and the second refresh mode is associated with a second quantity of refresh operations; and transmitting, to the memory device, a refresh command, where a quantity of refresh operations that is triggered based at least in part on the refresh command is equal to the first quantity or the second quantity based at least in part on the value of the mode register.

Aspect 10: The method, apparatus, or non-transitory computer-readable medium of aspect 9, further including operations, features, circuitry, logic, means, or instructions, or any combination thereof for detecting at least a threshold quantity of access operations executed in one or more memory locations during a threshold duration, where the change in the one or more parameters is based at least in part on detecting at least the threshold quantity of access operations executed.

Aspect 11: The method, apparatus, or non-transitory computer-readable medium of aspect 10, where setting the value of the mode register includes operations, features, circuitry, logic, means, or instructions, or any combination thereof for setting the value of the mode register to the first value associated with the first refresh mode of the memory device based at least in part on detecting at least the threshold quantity of access operations executed, where the quantity of refresh operations that is triggered based at least in part on the refresh command is at least two based at least in part on the first value of the mode register.

Aspect 12: The method, apparatus, or non-transitory computer-readable medium of any of aspects 9 through 11, further including operations, features, circuitry, logic, means, or instructions, or any combination thereof for receiving a request to change a refresh mode of the memory device, where the change in the one or more parameters is based at least in part on the request.

Aspect 13: The method, apparatus, or non-transitory computer-readable medium of any of aspects 9 through 12, where setting the value of the mode register includes operations, features, circuitry, logic, means, or instructions, or any combination thereof for setting the value of the mode register to the first value associated with the first refresh mode, where the first refresh mode includes a single refresh mode, and where the quantity of refresh operations that is triggered based at least in part on the refresh command is one based at least in part on the single refresh mode.

Aspect 14: The method, apparatus, or non-transitory computer-readable medium of any of aspects 9 through 13, where setting the value of the mode register includes operations, features, circuitry, logic, means, or instructions, or any combination thereof for setting the value of the mode register to the second value associated with the second refresh mode, where the second refresh mode includes a multi-refresh mode, and where the quantity of refresh operations that is triggered based at least in part on the refresh command is at least two based at least in part on the multi-refresh mode.

Aspect 15: The method, apparatus, or non-transitory computer-readable medium of any of aspects 9 through 14, where setting the value of the mode register includes operations, features, circuitry, logic, means, or instructions, or any combination thereof for transmitting, to the memory device, signaling that indicates to set the value of the mode register to the first value or the second value.

Aspect 16: The method, apparatus, or non-transitory computer-readable medium of any of aspects 9 through 15, where the one or more parameters indicate a vulnerability of the memory device to a threshold quantity of access operations executed in one or more memory locations during a threshold duration.

Aspect 17: The method, apparatus, or non-transitory computer-readable medium of any of aspects 9 through 16, where the one or more parameters indicate a type of application supported by the memory device.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code such as processor-executable code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
monitoring a state of refresh configuration circuitry of a memory system, wherein a first state of the refresh configuration circuitry indicates that the memory system operates in a first refresh mode associated with a first quantity of refresh operations and a second state of the refresh configuration circuitry indicates that the memory system operates in a second refresh mode associated with a second quantity of refresh operations;
receiving a refresh command for a memory array at the memory system; and
executing one or more refresh operations based at least in part on the refresh command, wherein a quantity of refresh operations included in the one or more refresh operations executed based at least in part on the refresh command is equal to the first quantity or the second quantity based at least in part on the state of the refresh configuration circuitry.

2. The method of claim 1, wherein executing the one or more refresh operations comprises:
executing a single refresh operation based at least in part on the refresh command, the single refresh operation based at least in part on the state of the refresh configuration circuitry being the first state associated with the first refresh mode, wherein the first refresh mode comprises a single refresh mode.

3. The method of claim 2, further comprising:
receiving a second refresh command for the memory array at the memory system; and
executing a second single refresh operation based at least in part on the second refresh command, the second single refresh operation based at least in part on the state of the refresh configuration circuitry being the first state associated with the first refresh mode, wherein the single refresh operation refreshes memory cells in a first word line of the memory array at the memory system and the second single refresh operation refreshes memory cells in a second word line of the memory array at the memory system.

4. The method of claim 1, wherein executing the one or more refresh operations comprises:
executing at least two refresh operations based at least in part on the refresh command, the at least two refresh operations based at least in part on the state of the refresh configuration circuitry being the second state associated with the second refresh mode, wherein the second refresh mode comprises a multi-refresh mode.

5. The method of claim 4, wherein executing the at least two refresh operations comprises:
executing, based at least in part on the refresh command, a first refresh operation to refresh first memory cells in a first word line of the memory array at the memory system; and
executing, based at least in part on the refresh command, after executing the first refresh operation, and before executing other refresh operations for the memory array, a second refresh operation to refresh second memory cells in a second word line of the memory array at the memory system.

6. The method of claim 1, wherein:
the refresh configuration circuitry comprises a mode register;
the first state corresponds to a first value of the mode register; and
the second state corresponds to a second value of the mode register.

7. The method of claim 6, further comprising:
receiving signaling that indicates to set the mode register to the first value or the second value, wherein monitoring the state of the refresh configuration circuitry is based at least in part on the signaling.

8. The method of claim 1, wherein:
the refresh configuration circuitry comprises one or more fuses on a memory die within the memory system;
the first state corresponds to the one or more fuses being blown; and
the second state corresponds to the one or more fuses not being blown.

9. A method, comprising:
detecting a change in one or more parameters associated with a refresh configuration for a memory device;
setting, based at least in part on the change in the one or more parameters, a value of a mode register associated with the memory device to a first value associated with a first refresh mode of the memory device or to a second value associated with a second refresh mode of the memory device wherein the first refresh mode is associated with a first quantity of refresh operations and the second refresh mode is associated with a second quantity of refresh operations; and
transmitting, to the memory device, a refresh command, wherein a quantity of refresh operations that is triggered based at least in part on the refresh command is equal to the first quantity or the second quantity based at least in part on the value of the mode register.

10. The method of claim 9, further comprising:
detecting at least a threshold quantity of access operations executed in one or more memory locations during a threshold duration, wherein the change in the one or more parameters is based at least in part on detecting at least the threshold quantity of access operations executed.

11. The method of claim 10, wherein setting the value of the mode register comprises:
setting the value of the mode register to the first value associated with the first refresh mode of the memory device based at least in part on detecting at least the threshold quantity of access operations executed, wherein the quantity of refresh operations that is triggered based at least in part on the refresh command is at least two based at least in part on the first value of the mode register.

12. The method of claim 9, further comprising:
receiving a request to change a refresh mode of the memory device, wherein the change in the one or more parameters is based at least in part on the request.

13. The method of claim 9, wherein setting the value of the mode register comprises:
setting the value of the mode register to the first value associated with the first refresh mode, wherein the first refresh mode comprises a single refresh mode, and wherein the quantity of refresh operations that is triggered based at least in part on the refresh command is one based at least in part on the single refresh mode.

14. The method of claim 9, wherein setting the value of the mode register comprises:
setting the value of the mode register to the second value associated with the second refresh mode, wherein the second refresh mode comprises a multi-refresh mode, and wherein the quantity of refresh operations that is triggered based at least in part on the refresh command is at least two based at least in part on the multi-refresh mode.

15. The method of claim 9, wherein setting the value of the mode register comprises:
transmitting, to the memory device, signaling that indicates to set the value of the mode register to the first value or the second value.

16. The method of claim 9, wherein the one or more parameters indicate a vulnerability of the memory device to a threshold quantity of access operations executed in one or more memory locations during a threshold duration.

17. The method of claim 9, wherein the one or more parameters indicate a type of application supported by the memory device.

18. An apparatus, comprising:
one or more memories storing processor-executable code; and
processing circuitry coupled with the one or more memories and operable to execute the code to cause the apparatus to:
monitor a state of refresh configuration circuitry of a memory system, wherein a first state of the refresh configuration circuitry indicates that the memory system operates in a first refresh mode associated with a first quantity of refresh operations and a second state of the refresh configuration circuitry indicates that the memory system operates in a second refresh mode associated with a second quantity of refresh operations;
receive a refresh command for a memory array at the memory system; and
execute one or more refresh operations based at least in part on the refresh command, wherein a quantity of refresh operations included in the one or more refresh operations executed based at least in part on the refresh command is equal to the first quantity or the second quantity based at least in part on the state of the refresh configuration circuitry.

19. The apparatus of claim 18, wherein, to execute the one or more refresh operations, the processing circuitry is operable to execute the code to cause the apparatus to:
execute a single refresh operation based at least in part on the refresh command, the single refresh operation based at least in part on the state of the refresh configuration circuitry being the first state associated with the first refresh mode, wherein the first refresh mode comprises a single refresh mode.

20. The apparatus of claim 18, wherein, to execute the one or more refresh operations, the processing circuitry is operable to execute the code to cause the apparatus to:
execute at least two refresh operations based at least in part on the refresh command, the at least two refresh operations based at least in part on the state of the refresh configuration circuitry being the second state associated with the second refresh mode, wherein the second refresh mode comprises a multi-refresh mode.

21. The apparatus of claim 20, wherein, to execute the at least to refresh operations, the processing circuitry is operable to execute the code to cause the apparatus to:
execute, based at least in part on the refresh command, a first refresh operation to refresh first memory cells in a first word line of the memory array at the memory system; and
execute, based at least in part on the refresh command, after executing the first refresh operation, and before executing other refresh operations for the memory array, a second refresh operation to refresh second memory cells in a second word line of the memory array at the memory system.

22. The apparatus of claim 18, wherein:
the refresh configuration circuitry comprises a mode register;
the first state corresponds to a first value of the mode register; and
the second state corresponds to a second value of the mode register.

23. The apparatus of claim 22, wherein the processing circuitry is operable to execute the code to cause the apparatus to:
receive signaling that indicates to set the mode register to the first value or the second value, wherein monitoring the state of the refresh configuration circuitry is based at least in part on the signaling.

24. The apparatus of claim 18, wherein:
the refresh configuration circuitry comprises one or more fuses on a memory die within the memory system;
the first state corresponds to the one or more fuses being blown; and
the second state corresponds to the one or more fuses not being blown.
